(19) United States
(12) Patent Application Publication
(10) Pub. No.: US 2025/0315825 A1
(43) Pub. Date: Oct. 9, 2025

(54) SYSTEMS AND METHODS FOR ANONYMOUS, PERSISTENT, AND PERMISSIONED NETWORK-BASED PAYMENTS

(71) Applicant: ASA TECHNOLOGIES, CORPORATION, Prova, UT (US)

(72) Inventors: Troy MAAS, Hillsboro, OR (US); Jay Landon GLENN, Provo, UT (US)

(73) Assignee: ASA TECHNOLOGIES, CORPORATION, Prova, UT (US)

(21) Appl. No.: 18/629,479

(22) Filed: Apr. 8, 2024

(51) Int. Cl. G06Q 20/40; G06Q 20/38

(52) U.S. Cl. CPC G06Q 20/401; G06Q 20/3827; G06Q 20/389

(57) ABSTRACT

Disclosed herein are system, method, and computer program product embodiments for anonymous, persistent, and permissioned payments. Embodiments comprise: receiving a request from a device, wherein the request includes an amount of funds, a payor identifier, and a payee identifier; obtaining permission for the request using the payor identifier; performing a first transfer in which the amount of funds is transferred from an account associated with the payor identifier to an account associated with a centralized server system; recording the amount of funds to a first blockchain node associated with the payor identifier, wherein the blockchain is managed by the centralized server system; performing a second transfer wherein the amount of funds is transferred from the account associated with the central server system to an account associated with the payee account identifier; and recording the amount of funds to a second blockchain node associated with the payee identifier.

### BACKGROUND

In a digital environment, data is often stored at a central location such as a data center. When data is communicated from or to the central location, these communications may also be recorded alongside the data at the central location. The recording may include what data was sent, when it was sent, a sender, and a receiver. This configuration places the data at risk because it is stored at a single, central location. For example, if the central storage location is subject to a cyber-attack, all of the data, including the records of communications, could be erased. An additional risk of this configuration is posed by the threat of a malicious actor tampering with the data. Since the data is stored at a central location: (1) external entities relying on this data may not be made aware of the tampering until they attempt to access it; and (2) the integrity of the data is left in the hands of a single entity managing the central location.

Additionally, since the information is maintained by single entity, that entity may communicate it without appropriate permission. For example, a bank maintaining a database of customer information may communicate information in the database to other parties without customer permission or knowledge. This not only presents security risks posed by sharing data without permission, it also inhibits anonymity. Another risk associated with this configuration is that the receiving entities rely on the central entity to keep track of the communication records. For example, if the central entity's records state that data was sent, but the recipient did not receive the data, the recipient has few ways to contest the discrepancy.

### BRIEF SUMMARY

Disclosed herein are system, apparatus, device, method and/or computer program product embodiments, and/or combinations and sub-combinations thereof, for anonymous, persistent, and permissioned network-based payments. Some embodiments relate to a method comprising: receiving a request from a device, where the request includes an amount of funds, a payor identifier, and a payee identifier; obtaining permission for the request via the payor identifier; in response to obtaining the permission, performing a first transfer, where the amount of funds is transferred from an account associated with the payor identifier to an account associated with a central server; in response to the first transfer, recording the amount of funds to a first node at a blockchain associated with the payor identifier, where the blockchain is managed by the central server; performing a second transfer, where the amount of funds is transferred from the central server account to an account associated with the payee account identifier; and in response to the second transfer, recording at a second node at the blockchain the amount of funds, where the second node is associated with the payee identifier.

Some embodiments relate to a system comprising: a memory and at least one processor coupled to the memory and configured to receive a request from a device, where the request includes an amount of funds, a payor identifier, and a payee identifier; obtain permission for the request via the payor identifier; in response to obtaining the permission, perform a first transfer, the amount of funds is transferred from an account associated with the payor identifier to an account associated with a central server; in response to the first transfer, record the amount of funds to a first node at a blockchain associated with the payor identifier, where the blockchain is managed by the central server; perform a second transfer, where the amount of funds is transferred from the central server account to an account associated with the payee account identifier; and in response to the second transfer, record at a second node at the blockchain the amount of funds, where the second node is associated with the payee identifier.

Some embodiments relate to a non-transitory computer-readable device having instructions stored thereon. When the instructions are executed by at least one computing device, the instructions cause the at least one computing device to perform operations comprising: receiving a request from a device, where the request includes an amount of funds, a payor identifier, and a payee identifier; obtaining permission for the request via the payor identifier; in response to obtaining the permission, performing a first transfer, where the amount of funds is transferred from an account associated with the payor identifier to an account associated with a central server; in response to the first transfer, recording the amount of funds to a first node at a blockchain associated with the payor identifier, where the blockchain is managed by the central server; performing a second transfer, where the amount of funds is transferred from the central server account to an account associated with the payee account identifier; and in response to the second transfer, recording at a second node at the blockchain the amount of funds, where the second node is associated with the payee identifier.

### BRIEF DESCRIPTION OF THE DRAWINGS

The accompanying drawings are incorporated herein and form a part of the specification.

FIG. 1 depicts an exemplary system for anonymous, persistent, and permissioned network-based payments, according to some embodiments.

FIG. 2 depicts a block diagram of an exemplary blockchain for facilitating anonymous, persistent, and permissioned network-based payments, according to some embodiments.

FIG. 3 depicts a block diagram of an exemplary node, according to some embodiments.

FIG. 4 depicts an exemplary user interface, according to some embodiments.

FIG. 5 is a flowchart illustrating an example process for providing anonymous, persistent, and permissioned network-based payments, according to some embodiments.

FIG. 6 is a flowchart illustrating an example process for executing a smart contract, according to some embodiments.

FIG. 7 is a flowchart illustrating a process for validating a blockchain, according to some embodiments.

FIG. 8 is a flowchart illustrating a process for validating nodes within a blockchain, according to some embodiments

FIG. 9 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for anonymous, persistent, and permissioned network-based payments. In an effort to overcome risks associated with typical centralized payment environments, embodiments may utilize a privately managed blockchain. In some embodiments, the blockchain may be a linked list of nodes, where each node includes data. Blockchain nodes may be linked via cryptographic hash values. The cryptographic hash may be a one way function such that it is irreversible. The cryptographic hash may also be designed such that the chance of collision (e.g., no two inputs map to the same output) is negligible. When a blockchain includes only a single node, the hash value may be computed using the data at the single node and stored as part of that node. When a second node is added, the hash value may be computed using: (1) data at the second node; and (2) the hash value at the first node. Including the first node's hash value creates a link between the first node and second node. This operation is repeated for each node added to the blockchain. Since data written to the blockchain is copied and stored by multiple participating entities, the risk of the data being tampered with by malicious actors is greatly reduced. Moreover, use of a private, permissioned blockchain ensures access is restricted to authorized parties and reduces computational complexity of transactions due to a smaller user base, increasing the overall speed of transactions.

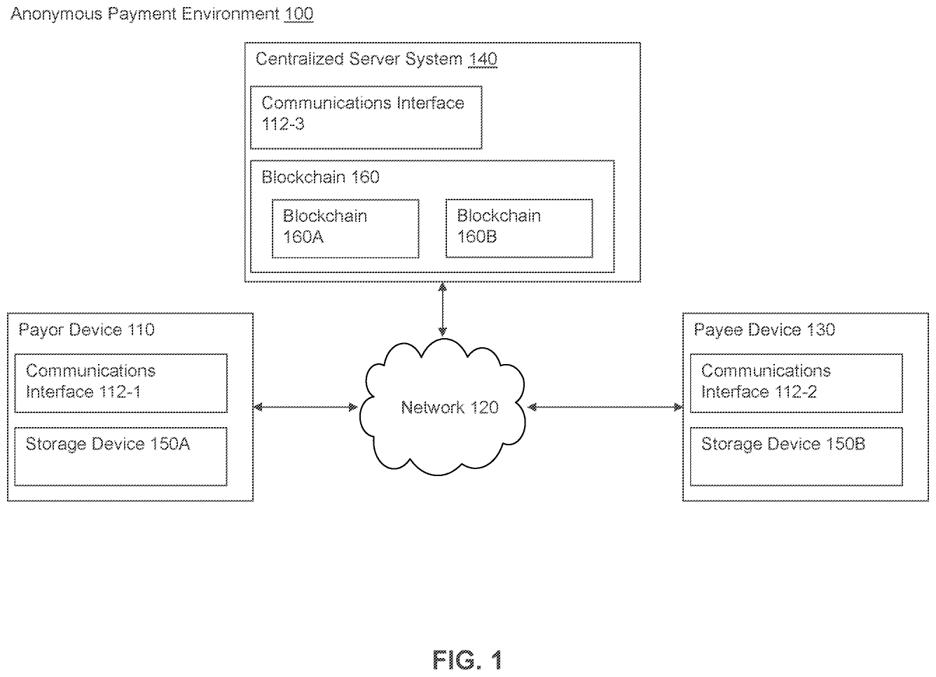

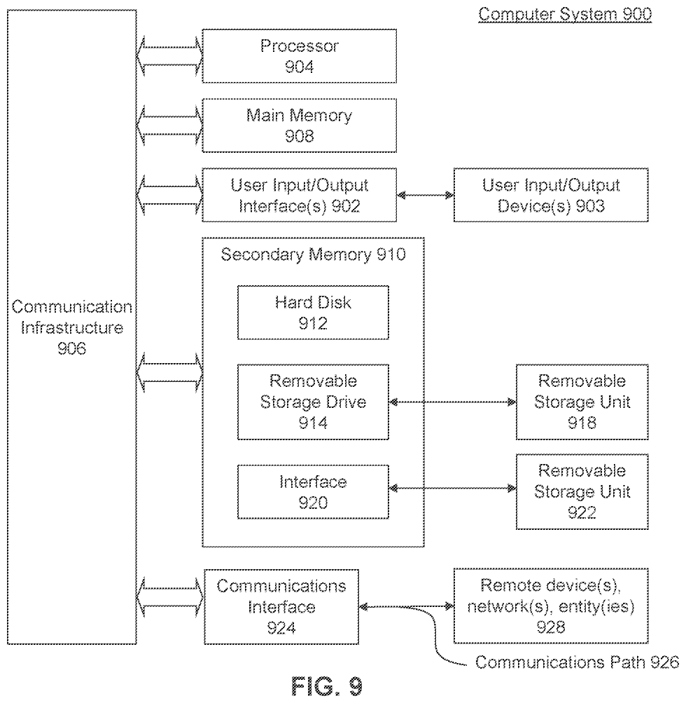

FIG. 1 depicts an exemplary system for anonymous, persistent, and permissioned network-based payments, according to some embodiments. Anonymous payment environment 100 may include payor device 110, network 120, payee device 130, and centralized server system 140. Payor device 110 may be may be a computer system such as computer system 900 described with reference to FIG. 9. Payor device 110 may be a client system such as a desktop workstation, laptop or notebook computer, netbook, tablet, smart phone, and/or other computing device that may be using an enterprise computing system. Payor device 110 may include storage device 150A. Storage device 150A may be a memory storage device. Payor device 110 may communicate with payee device 130 and central server 140 via network 120. In some embodiments, payor device 110 may use communications interface 112-1 to perform the communication. In some embodiments, payor device 110 may initiate a request (e.g., a payment request, a transaction request, etc.) to send funds to an account associated with payee device 130. In some embodiments, payee device 130 may initiate a request to have funds sent to its account from an account associated with payor device 110.

In some embodiments, the request may include an amount of funds, a payor identifier, and a payee identifier. The amount of funds may be, for example, an amount of money that payor device 110 wishes to transfer from an account associated with payor device 110 (e.g., a bank account) to an account associated with payee device 130. The payor identifier may be a field used to identify payor device 110 on network 120. The payor identifier may include letters, numbers, and/or characters. The payee identifier may be a field used to identify payee device 130 on network 120. The payor and payee identifiers may be designed to hide: (1) the identities of the entities associated with payor and payee identifiers; and (2) account information associated with the payor and payee. For example, a payor associated with payor device 110 may make periodic payments to a payee's account. However, the payor may not wish for the payee to have access to identity or account information of the payor. In order to protect this information, the payor may use a payor identifier to hide their identity. Additionally, the payor identifier may hide the payor's account information. Centralized server system 140 may be used to determine a payor and payee account in order to appropriately debit and credit the funds. In some embodiments, centralized server system 140 may use the payor and payee identifiers to determine which accounts to use.

Network 120 may be any type of computer or telecommunications network capable of communicating data, for example, a local area network, a wide-area network (e.g., the Internet), or any combination thereof. The network may include wired and/or wireless segments. In some embodiments, network 120 may be a secure network. Moreover, network 120 may be a private network where access is restricted to authorized entities. In some embodiments, access to network 120 may be controlled and managed by centralized server system 140, as discussed further below.

Payee device 130 may be may be a computer system such as computer system 900 described with reference to FIG. 9. Payee device 130 may be a client system such as a desktop workstation, laptop or notebook computer, netbook, tablet, smart phone, and/or other computing device that may be using an enterprise computing system. Payee device 130 may include storage device 150B. Storage device 150B may be a memory storage device. Payee device 130 may communicate with payor device 110 and centralized server system 140. In some embodiments, payee device 130 may use communications interface 112-2 to perform the communication. Payee device 130 may receive and initiate transaction requests to receive funds from an account associated with payor device 110.

Centralized server system 140 may be implemented using one or more servers and/or databases. In some embodiments, each server of centralized server system 140 may be implemented using a computing device such as a desktop workstation, laptop or notebook computer, netbook, tablet, smart phone, and/or other computing device. In some embodiments, each server of centralized server system 140 may be implemented as an application in an enterprise computing and/or a cloud-computing environment. In some embodiments, each server of centralized server system 140 may be a computer system such as computer system 900 described with reference to FIG. 9. Centralized server system 140 may communicate with payor device 110 and payee device 130 via network 120. In some embodiments, centralized server system 140 may use communications interface 112-3 to communicate. Centralized server system 140 may determine which entities can access network 120. For example, centralized server system 140 may control payor device's 110 and payee device's 130 access to network 120.

Entities connected to network 120 may have access to blockchain 160. Blockchain 160 may be used to record data communicated within network 120. For example, data sent between payor device 110 and payee device 130 may be recorded on blockchain 160. Additionally, payments made from an account associated with payor device 110 to an account associated with payee device 130 may also be recorded at blockchain 160. Allowing each entity on network 120 access to blockchain 160 (or a subset thereof) enables data of blockchain 160 to be copied and/or distributed throughout network 120, greatly reducing the risk of loss associated with maintaining a single copy of all data in one centralized location.

Each entity may view the entirety, or only a portion of blockchain 160. Centralized server system 140 may have access to the entirety of blockchain 160. Payor device 110 may only have permission to access a subset of blockchain 160 (e.g., blockchain 160A). Similarly, payee device 130 may only have access to a subset of blockchain 160 (e.g., blockchain 160B). As stated above, payor device 110 may include storage device 150A, and payee device 130 may include storage device 150B. Storage device 150 may be used to store data copied from blockchain 160. For example, payor device 110 may be allowed to view data at blockchain 160A and copy it to storage device 150A. Similarly, payee device 130 may be allowed to view data at blockchain 160B and copy it to storage device 150B

In some embodiments, blockchain 160A and blockchain 160B may be subsets of blockchain 160, meaning that they do not include all the data from blockchain 160. In some embodiments, blockchain 160A may be the same as blockchain 160, whereas blockchain 160B may be a subset of blockchain 160, or vice versa. In some embodiments, blockchain 160A and blockchain 160B may both be the same as blockchain 160.

In some embodiments, permissions associated with accessing blockchain 160 may be updated. For example, a second payee device 130 (e.g., payee device 130-1) may be added to network 120 and also be allowed to access a subset of blockchain 160 (e.g., blockchain 160C). In some embodiments, a device may have their access removed. For example, following a transaction, centralized server system 140 may remove payor device's 110 access to blockchain 160.

In some embodiments, an entity may not be able to view, access, or otherwise interact with blockchain 160. As stated above, a benefit of the current system is the ability to facilitate anonymous, persistent, and permissioned payments. Thus, there is a need to strictly control which entities may access blockchain 160. Therefore, centralized server system 140 may determine and control entity (e.g., payor device 110, payee device 130) access to blockchain 160. For example, blockchain 160 and/or network 120 may be password protected.

As noted above, centralized server system 140 may dictate what portion of blockchain 160 each device on network 120 has access to. For example, payor device 110 may only have access to view and interact with a portion of blockchain 160 (e.g., blockchain 160A), that involves payor device 110. Therefore, payor device 110 may not be able to view and interact with the portion of blockchain 160, blockchain 160B, that is associated with payee device 130. Restricting access to blockchain 160 helps improve privacy and anonymity because each entity may only access data regarding their own transactions. For example, payor device 110 may only view its own transactions, and not those related to payee device 130.

Entities may interact (e.g., copy data) with blockchain 160 via smart contracts. Data copied from blockchain 160, and data at blockchain 160, should match to ensure transactional integrity. For example, data copied from blockchain 160 and stored at storage device 150A at payor device 110 should match the nodes at blockchain 160 from which the data was copied. Centralized server system 140 and payor device 110 may be able to verify the integrity of their respective blockchain portions. The integrity of the data may be determined by each entity computing a hash of their portion of the data and comparing the values. If the values are the same, then: (1) the data was copied correctly; and (2) blockchain 160 has not been improperly altered since the copying occurred. This comparison functionality reduces tampering risk associated with storing data at a centralized location. For example, if a malicious actor attempts to alter a portion of blockchain 160 at centralized server system 140, and payor device 110 has copied that data, payor device 110 may detect an anomaly by comparing hash values of data at storage device 150A (e.g., the payor device local copy) to the hash values of data at blockchain 160. Such validation of hash values across copies of blockchain 160 not only ensures transactional integrity, it increases security and improves network efficiency by transmitting only calculated hash values. Since these hash values are fixed-size and irreversible, actual transaction data stored within blockchain nodes need not be transmitted across network 120 as part of this verification process.

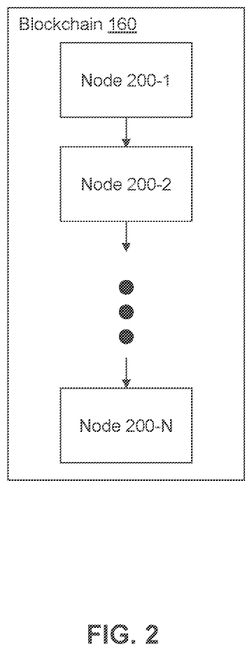

FIG. 2 depicts a block diagram of an exemplary blockchain 160 for facilitating anonymous, persistent, and permissioned network-based payments, according to some embodiments. As depicted, blockchain 160 may include multiple nodes 200-1 to 200-N. Each node 200 may include data such as transaction data. The transaction may include payments between entities on network 120. Nodes 200 within blockchain 160 may be linked. As described above, nodes 200 may be linked via a hash algorithm. A hash algorithm may be an algorithm that receives an input, and generates an output. Example hash algorithms include, for example and without limitation, the SHA (Secure Hash Algorithm) family of hash algorithms (e.g., SHA-256), CRC, MD5, and BLAKE2. The output of the hash algorithm may have a fixed size, regardless of the input size. The hash algorithm may be designed so that the input is irrecoverable from the output. For example, once the hash (e.g., the output) is created from the input, there may be no way to recover the input from the hash. The hash algorithm may also be designed to be collision resistant, such that no two inputs produce the same output. This may be desirable so that each input produces a unique output.

Nodes 200 are linked by storing a hash from the previous node in the current node. For example, node 200-2 includes a hash of node 200-1. The hash of node 200-1 may be a hash computed over the data stored at node 200-1. Since the hash algorithm is designed to generate a unique output for each input, hash values may be compared to determine whether data at a node, such as node 200, was tampered with. For example, if a node 200 contains no data, a first hash value of 0 may be computed. If data is added to node 200, a second hash value of 1 may be computed. In this example, since the first and second hash values differ, a determination may be made that node 200 was altered in some manner. By distributing copies of blockchain 160 across entities, the integrity of blockchain 160 can be easily verified through comparison of node hash values.

Nodes 200 may be added in response to various events. For example, if an entity such as payor device 110 is added to network 120 by centralized server system 140, a node 200 may be added to blockchain 160. As another example, a node 200 may be added to reflect a funds transfer from payor device 110 to payee device 130.

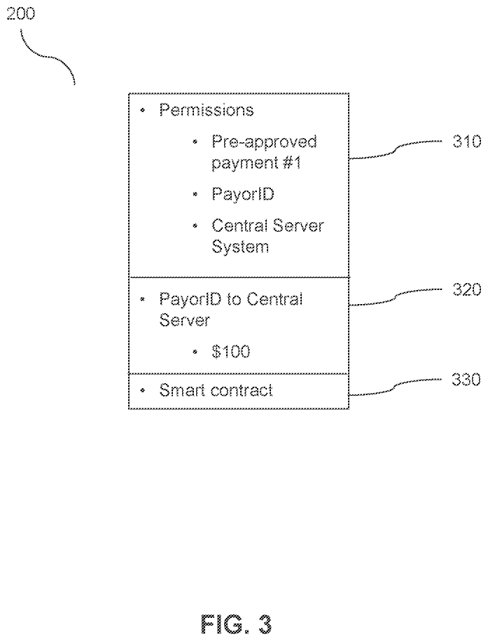

FIG. 3 depicts a block diagram of an exemplary node 200, according to some embodiments. Node 200 may be part of blockchain 160. Node 200 may include permissions 310. Permissions 310 may include a list of preapproved transactions. Although a single preapproved transaction is shown, permissions 310 may include multiple preapproved transactions.

For example, payor device 110 may preapprove a payment transaction to an account linked to payee device 130, and centralized server system 140 may record this preapproval at node 200. This may be useful so that if payee device 130 requests payment, permission can be obtained by consulting node 200. Such a process: (1) improves network efficiency because the payor does not have to be consulted each time the preapproved payment is requested; and (2) improves security because changes in node 200 are detectable by computing hash value of node 200. Thus, any malicious attempt by a payee to alter node 200 and add a preapproved payment will be detected via the altered hash value. Permissions 310 may further include the identities of entities that can view and/or edit node 200. For example, permissions 310 may include PayorID, an identifier associated with payor device 110, thereby allowing payor device 110 to view node 200. Here, payee device 130 may not view node 200 since permissions 310 does not include an identifier associated with payee device 130.

Centralized server system 140 may use permissions 310 to enforce which entities can view which parts of blockchain 160. For example, when payor device 110 is added to network 120, centralized server system 140 may create a node 200 that includes a payorID associated with payor device 110 within permissions 310. The portion of blockchain 160 payor device 110 has access to may be denoted by blockchain 160A. Subsequently, payor device 110 may be able to view and copy data from blockchain 160A. Centralized server system 140 may view blockchain 160 to determine which entities can view the new node 200. Additionally, payor device 110 may verify data at node 200 by calculating and comparing a hash of node 200 with a copy of data from node 200 stored at storage device 150A.

Each node 200 may include transaction data, such as transaction entry 320. Although a single transaction entry 320 is shown, node 200 may include multiple transaction entries 320. Transaction entry 320 may be written to node 200 when a transaction occurs between entities that have permission to edit node 200. Transaction entry 320 may include different types of information. For example, transaction entry 320 may include a source (e.g., PayorID), a recipient (e.g., Central Server), and an amount (e.g., $100).

Blockchain node 200 may include smart contract 330. Smart contract 330 may be a computer program configured to execute when a condition is met. Smart contract 330 may be configured to add a transaction entry 320 when a transaction occurs. For example, smart contract 330 may be configured to monitor accounts associated with centralized server system 140 and payee device 130, and then write to node 200 when funds are transferred between the accounts. Utilizing smart contract 330 reduces the risk of manually recording data and/or transactions. Additionally, smart contract 330 may be configured to record all data and/or transactions that occur. This may be to provide persistent and redundant copies of data sent within network 120.

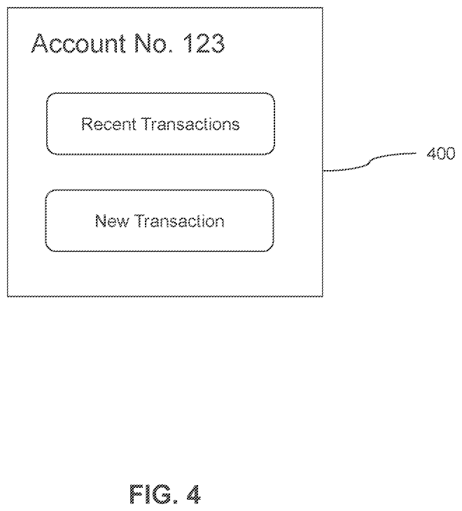

FIG. 4 depicts an exemplary user interface 400, according to some embodiments. Centralized server system 140 may host interface 400. Interface 400 may be accessed by an entity on network 120, such as payor device 110 or payee device 130. Interface 400 may include various utilities. For example, interface 400 may provide access to recent transactions within blockchain 160 to which the device has access. In some embodiments, interface 400 may only provide access to the local copy of blockchain 160 at the device where interface 400 is accessed. For example, payor device 110 may only be able to view data within blockchain 160A, local to payor device 110, and payee device 130 may only be able to view data within blockchain 160B. However, centralized server system 140 may be able to view the entire blockchain (i.e., blockchain 160). Selecting “New Transaction” may require various inputs such as an amount of funds, a payor identifier, a payee identifier, and a payee account identifier. This data may be sent to centralized server system 140 in order to initiate the transaction process.

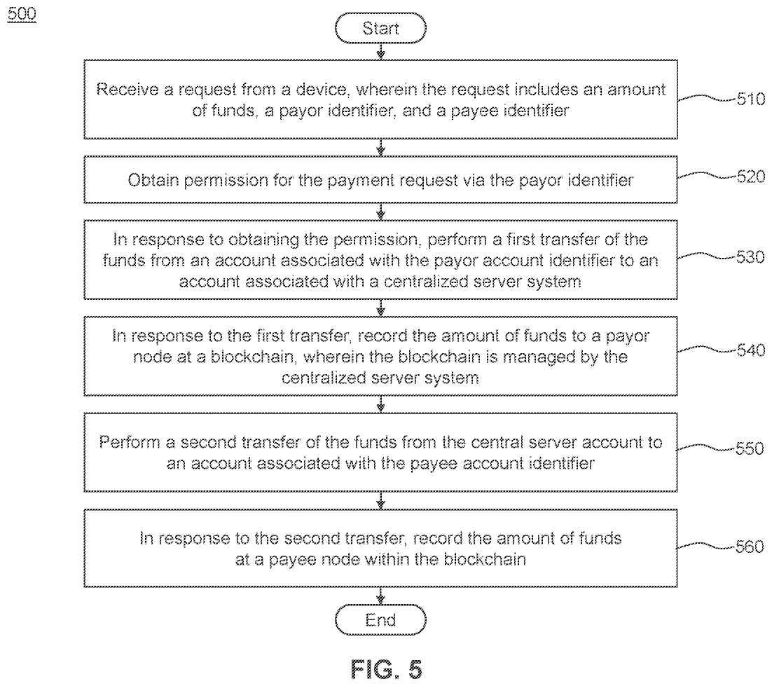

FIG. 5 is a flowchart illustrating an example process 500 for providing anonymous, persistent, and permissioned network-based payments, according to some embodiments. Process 500 may be performed by processing logic that may comprise hardware (e.g., circuitry, dedicated logic, programmable logic, microcode, etc.), software (e.g., instructions executing on a processing device), or a combination thereof. One or more of the steps in FIG. 5 may be performed by payor device 110, payee device 130, alone or in combination with centralized server system 140. In some embodiments, one or more of the steps shown in FIG. 5 may be omitted, repeated, and/or performed in a different order than the order shown in FIG. 5. Accordingly, the scope of the invention should not be considered limited to the specific arrangement of steps shown in FIG. 5. The steps shown in FIG. 5 may be implemented as computer-readable instructions stored on computer-readable media, where, when the instructions are executed, cause a processor to perform the process of FIG. 5.

At 510, a request is received from a device. The request may include an amount of funds, a payor identifier, and a payee identifier. In some embodiments, the request may be sent from payor device 110 to centralized server system 140. In some embodiments, the request may be sent from payee device 130 to centralized server system 140.

At 520, permission is obtained for the request using the payor identifier. Centralized server system 140 may use blockchain 160 to obtain permission. In some embodiments, node 200 at blockchain 160 may include permissions 310. Permissions 310 may include a payment preapproval that matches the details of the request. A match may indicate that the amount of funds, the payor identifier, and the payee identifier in the request match their corresponding values at permissions 310. If the request does not match a preapproved payment at permissions 310, or permissions 310 does not include any preapproved payments, centralized server system 140 may send a request (e.g., instant message, email, SMS message, phone call, etc.) to payor device 110 to obtain approval. In some embodiments, the request may cause an interface, such as interface 400, to display on payor device 110. Payor device 110 may use interface 400 to grant or deny permission.

At 530, in response to obtaining the permission, a first transfer is performed in which the amount of funds is transferred from an account associated with the payor identifier to an account associated with centralized server system 140. In some embodiments, the payor account identifier may be linked to payor device 110.

At 540, in response to the first transfer, the amount of funds is recorded to a payor node at blockchain 160. Blockchain 160 may be managed by centralized server system 140. For example, transaction entry 320, as depicted in FIG. 3, may be added to node 200 at blockchain 160. In some embodiments, the recording may be performed by the execution of a smart contract. In some embodiments, data from the updated node 200 may be transmitted to entities listed in the permissions 310 of node 200. For example, centralized server system 140 may update node 200, and payor device 110 may be listed in node's 200 permissions 310. Therefore, centralized server system 140 may transmit data from the updated node 200 to payor device 110 so that payor device 110 may store a copy of the data at storage device 150A.

At 550, a second transfer is performed in which the amount of funds is transferred from centralized server system 140 to an account associated with the payee identifier. The payee identifier may be associated with payee device 130.

At 560, in response to the second transfer, the amount of funds is recorded at a payee node at blockchain 160. The transfer may be recorded by centralized server system 140. In some embodiments, recording may be performed in response to the execution of a smart contract. In response to recording, centralized server system 140 may transmit data from the updated node to payee device 130 so that it can store the data at storage device 150B.

A benefit of first transferring funds to an account at centralized server system 140, instead of directly the payee, is that it helps maintain privacy and security of the entities involved. First, payment account information may be kept between payor device 110 and centralized server system 140; there is no need to give payee device 130 any information regarding payor device 110's payment accounts. Second, such operation also improves portability. For example, payor device 110 may change the account from which it makes payments. In such a case, payor device 110 need only update centralized server system 140 because centralized server system 140, not payee device 130, interacts with the payment account. Payor 110 is thus able to maintain a level of anonymity with respect to payees—payees receive only information necessary to process a payment (e.g., the amount of funds transferred).

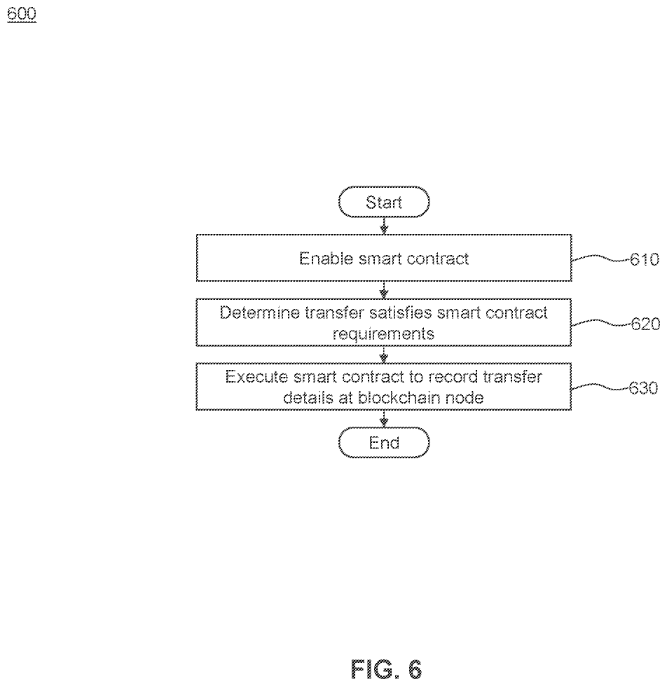

FIG. 6 is a flowchart illustrating an example process 600 for executing a smart contract, according to some embodiments. In some embodiments, the smart contract may be implemented as software code configured to execute upon a condition occurring. Process 600 may be performed by processing logic that may comprise hardware (e.g., circuitry, dedicated logic, programmable logic, microcode, etc.), software (e.g., instructions executing on a processing device), or a combination thereof. One or more of the steps in FIG. 6 may be performed by payor device 110, payee device 130, alone or in combination with centralized server system 140. In some embodiments, one or more of the steps shown in FIG. 6 may be omitted, repeated, and/or performed in a different order than the order shown in FIG. 6. Accordingly, the scope of the invention should not be considered limited to the specific arrangement of steps shown in FIG. 6. The steps shown in FIG. 6 may be implemented as computer-readable instructions stored on computer-readable media, where, when the instructions are executed, cause a processor to perform the process of FIG. 6.

At 610, a smart contract is enabled. The smart contract may be, for example, smart contract 330 stored at node 200. In some embodiments, centralized server system 140 may enable smart contract 330. Smart contract 330 may relate to a transaction and include certain requirements. For example, smart contract 330 may be configured to monitor accounts associated with payor device 110 and centralized server system 140. Smart contract 330 may further be configured to detect a monetary transfer of a specified amount from an account associated with a payor device, such as payor device 110, to the centralized server system 140 account.

At 620, a determination is made as to whether the transfer satisfies the smart contract requirements. Smart contract 330 may query the accounts to determine whether the transfer was made. For example, smart contract 330 may query the payor device 110 account to identify a debit of $100, and query the centralized server system 140 account identifying a credit of $100.

At 630, smart contract 330 is executed to record transfer details at a blockchain node, such as node 200 of FIG. 3. The transfer details may be recorded in transaction entry 320. For example, the details may include a source and a recipient such as PayorID and Centralized Server System, as well as the amount of the transfer (e.g., $100). In some embodiments, data from updated node 200 may be transmitted to entities included in permissions 310 so that they can update their local data stores. For example, if smart contract 330 is executed on a node at blockchain 160A, associated with payor device 110, centralized server system 140 may send a copy of the data at updated node to payor device 110 so it can store the data at storage device 150A.

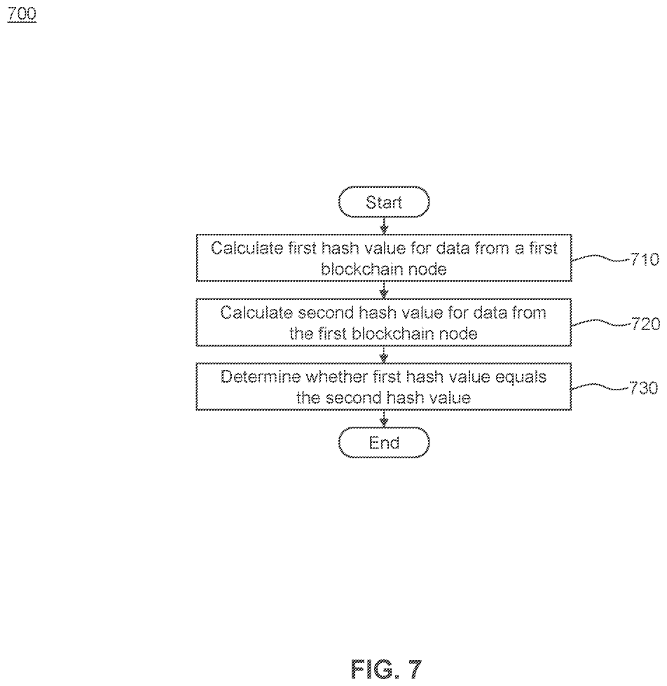

FIG. 7 is a flowchart illustrating an example process 700 for validating a blockchain, according to some embodiments. Validation may include computing the hash value of data from of same blockchain node, stored by different entities, to compare blockchain data. As stated above, entities on network 120 may store copies of data from blockchain 160. The process depicted in flowchart 700 enables the integrity of a blockchain to be validated through comparison of hash values across copies of data stored by these entities. Process 700 may be performed by processing logic that may comprise hardware (e.g., circuitry, dedicated logic, programmable logic, microcode, etc.), software (e.g., instructions executing on a processing device), or a combination thereof. One or more of the steps in FIG. 7 may be performed by payor device 110, payee device 130, alone or in combination with centralized server system 140. In some embodiments, one or more of the steps shown in FIG. 7 may be omitted, repeated, and/or performed in a different order than the order shown in FIG. 7. Accordingly, the scope of the invention should not be considered limited to the specific arrangement of steps shown in FIG. 7. The steps shown in FIG. 7 may be implemented as computer-readable instructions stored on computer-readable media, where, when the instructions are executed, cause a processor to perform the process of FIG. 7.

At 710, a first hash value is calculated for data from a first blockchain node. The first blockchain node may be, for example, node 200-1 on blockchain 160 stored at centralized server system 140 (as depicted in FIG. 2). In some embodiments, the first hash value may be calculated by centralized server system 140. Further, in some embodiments, the first hash value may be calculated by inputting the data stored within node 200-1 to a cryptographic hash algorithm. Example hash algorithms include, for example and without limitation, the SHA (Secure Hash Algorithm) family of hash algorithms (e.g., SHA-256), CRC, MD5, and BLAKE2.

At 720, a second hash value is calculated for data from the first blockchain node. The second hash value may be calculated by payor device 110 using data stored at storage device 150A. The data may have been copied from node 200-1 at blockchain 160A. The second hash value may be calculated by inputting the data at to a cryptographic hash algorithm.

At 730, a determination is made as to whether the first hash value equals the second hash value. In some embodiments, payor device 110 may transmit, via network 120, its calculated hash value to centralized server system 140 for comparison. If the hash values are determined to be equal, the integrity of the data within node 200-1 of blockchain 160 is validated. If the values are unequal, this may indicate that there is a data discrepancy between blockchain 160 and data stored at storage device 150A. For example, a node 200-1 in blockchain 160 may have transaction entry 320 that is not present in the data stored within storage device 150A.

Although process 700 is discussed as involving centralized server system 140 and payor device 110, process 700 may be performed between any entities on network 120. Additionally, any entity may initiate process 700. For example, payor device 110 may initiate process 700 by sending a message to centralized server system 140. In some embodiments, the message may include a request to verify blockchain 160, as well as a designation of a node to verify. In some embodiments, the node may be identified by a node identifier. In some embodiments, the node identifier may be the calculated hash value.

In applying process 700, improved network performance may be achieved. For example, instead of having to transmit and compare the actual data stored at payor device 110 and centralized server system 140, each entity may transmit the calculated hash value. Since the hash value is typically a fixed length and smaller than the size of the actual data stored in the blockchain node, validating blockchain 160 may not grow in complexity with the number of nodes 200 in blockchain 160. Additionally, process 700 improves network and computer security. For example, instead of transmitting actual data over network 120 when validating the blockchain, process 700 involves transmits only the computed hash values. Even if a malicious actor were to gain access to these hash values, the actor would not be able to determine the contents of actual data stored at centralized server system 140, payor device 110, and/or payee device 130.

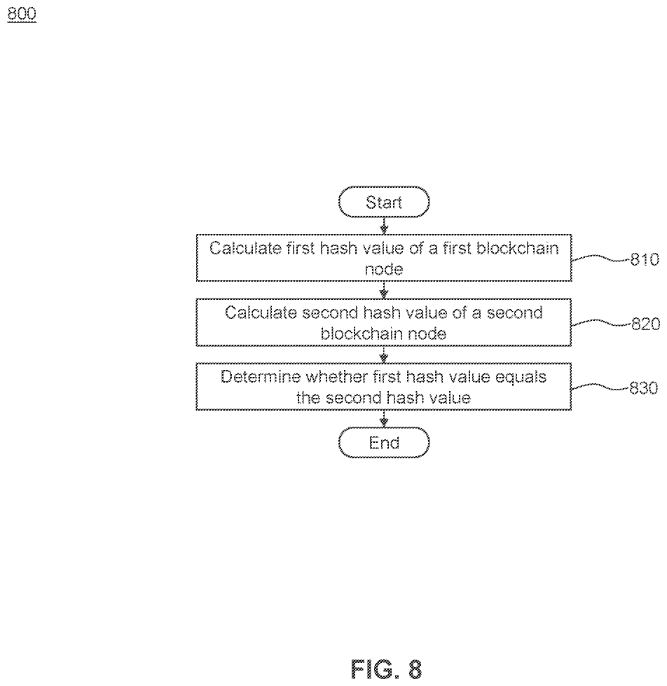

FIG. 8 is a flowchart illustrating an example process 800 for validating nodes within a blockchain, according to some embodiments. Validation may include computing and comparing the hash value of two or more blockchain nodes to compare blockchain data. Process 800 may be used to validate nodes that are accessible by different entities. For example, payor device 110 may have executed a transaction to transfer funds to an account associated with payee device 130. However, payor device 110 and payee device 130 may be restricted from accessing each other's portions of blockchain 160. For example, payor device 110 may access blockchain 160A, whereas payee device 130 may access blockchain 160B. Following the transfer, the transfer amount may be recorded at nodes located at blockchain 160A and blockchain 160B. Process 800 may be used by payor device 110 and payee device 130 to validate that the proper amount was recorded at each node. The process depicted in flowchart 800 enables the integrity of a blockchain to be validated through comparison of hash values across copies of data stored by these entities. Process 800 may be performed by processing logic that may comprise hardware (e.g., circuitry, dedicated logic, programmable logic, microcode, etc.), software (e.g., instructions executing on a processing device), or a combination thereof. One or more of the steps in FIG. 8 may be performed by payor device 110, payee device 130, alone or in combination with centralized server system 140. In some embodiments, one or more of the steps shown in FIG. 8 may be omitted, repeated, and/or performed in a different order than the order shown in FIG. 8. Accordingly, the scope of the invention should not be considered limited to the specific arrangement of steps shown in FIG. 8. The steps shown in FIG. 8 may be implemented as computer-readable instructions stored on computer-readable media, where, when the instructions are executed, cause a processor to perform the process of FIG. 8.

At 810, a first hash value is calculated of a first blockchain node. The first blockchain node may be, for example, node 200-1 on blockchain 160 stored at centralized server system 140 (as depicted in FIG. 2). The first blockchain node may be part of blockchain 160 associated with payor device 110 (e.g., blockchain 160A). In some embodiments, the first hash value may be calculated by payor device 110. Further, in some embodiments, the first hash value may be calculated by inputting the data stored within node 200-1 to a cryptographic hash algorithm. Example hash algorithms include, for example and without limitation, the SHA (Secure Hash Algorithm) family of hash algorithms (e.g., SHA-256), CRC, MD5, and BLAKE2.

At 820, a second hash value is calculated of a second blockchain node. The second blockchain node may be part of blockchain 160 associated with payee device 130 (e.g., blockchain 160B). The second hash value may be calculated by payee device 130. The second hash value may be calculated by inputting the data at to a cryptographic hash algorithm.

At 830, a determination is made as to whether the first hash value equals the second hash value. In some embodiments, payor device 110 and payee device 130 may transmit, via network 120, their calculated hash values to centralized server system 140 for comparison. If the hash values are determined to be equal, the integrity of the data within the nodes of blockchain 160 is validated. If the values are unequal, this may indicate that there is a data discrepancy between nodes at blockchain 160. Centralized server system 140 may transmit results of the comparison to the involved entities (e.g., payor device 110 and payee device 130).

As an example, payor device 110 may have executed a transaction to transfer $100 to an account associated with payee device 130. The transfer may be recorded at a node of blockchain 160, accessible by payor device 110 (e.g., blockchain 160A), but not payee device 130. Similarly, the transfer may also be recorded at a node accessible by payee device 130, but not payor device 110 (e.g., blockchain 160B).

In this scenario, payor device 110 and payee device 130 may wish to determine the transfer was properly recorded on blockchain 160, without gaining access to each other's nodes in order to preserve anonymity and privacy. Using process 800, payor device 110 and payee device 130 may respectively calculate hash values for the nodes recording the transfer, and send the values to centralized server system 140 for comparison. If the same transfer value (e.g., $100) was recorded at each node, the hash values should be equal. Thus, payor device 110 and payee device 130 may be ensured that blockchain 160 includes consistent data reflecting the transfer.

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for anonymous, persistent, and permissioned network-based payments, comprising:
receiving a request from a device, wherein the request includes an amount of funds, a payor identifier, and a payee identifier;
obtaining permission for the request using the payor identifier;
in response to obtaining the permission, performing a first transfer, wherein the amount of funds is transferred from an account associated with the payor identifier to an account associated with a centralized server system;
in response to the first transfer, recording the amount of funds to a first node on a blockchain managed by the centralized server system, wherein the first node is associated with the payor identifier;
performing a second transfer, wherein the amount of funds is transferred from the account associated with the centralized server system to an account associated with the payee identifier; and
in response to the second transfer, recording the amount of funds to a second node on the blockchain, wherein the second node is associated with the payee identifier.

2. The computer-implemented method of claim 1, wherein recording the first transfer is performed by executing a smart contract configured to execute when the first transfer is complete, and wherein recording the second transfer is performed by executing a smart contract configured to execute when the second transfer is complete.

3. The computer-implemented method of claim 1, wherein obtaining permission for the request further comprises receiving approval from a payor device associated with the payor identifier.

4. The computer-implemented method of claim 1, wherein obtaining permission for the request further comprises comparing the request to the first node, wherein the first node includes an entry indicating preapproval of the request.

5. The computer-implemented method of claim 1, wherein the first node includes a permission list, the permission list including the payor identifier and the payee identifier, wherein the permission list provides access to view and edit the first node.

6. The computer-implemented method of claim 1, further comprising verifying the first transfer and the second transfer, the verifying comprising:
calculating a first hash value of the first node;
calculating a second hash value of the second node; and
determining that the first hash value equals the second hash value.

7. The computer-implemented method of claim 6, wherein the first hash value and the second hash value are calculated using a one-way, cryptographic hash function.

8. A system for anonymous, persistent, and permissioned network-based payments, comprising:
a memory; and
at least one processor coupled to the memory and configured to:
receive a request from a device, wherein the request includes an amount of funds, a payor identifier, and a payee identifier;
obtain permission for the request using the payor identifier;
in response to obtaining the permission, perform a first transfer wherein the amount of funds is transferred from an account associated with the payor identifier to an account associated with a centralized server system;
in response to the first transfer, record the amount of funds to a first node on a blockchain managed by the centralized server system, wherein the first node is associated with the payor identifier;
perform a second transfer, wherein the amount of funds is transferred from the account associated with the centralized server to an account associated with the payee identifier; and
in response to the second transfer, record the amount of funds to a second node on the blockchain, wherein the second node is associated with the payee identifier.

9. The system of claim 8, wherein to record the first transfer the at least one processor is further configured to execute a smart contract when the first transfer is complete, and wherein to record the second transfer the at least one processor is further configured to execute a smart contract when the second transfer is complete.

10. The system of claim 8, wherein obtaining permission for the request further comprises receiving approval from a payor device associated with the payor identifier.

11. The system of claim 8, wherein obtaining permission for the request further comprises comparing the request to the first node, wherein the first node includes an entry indicating preapproval of the request.

12. The system of claim 8, wherein the first node includes a permission list, the permission list including the payor identifier and the payee identifier, wherein the permission list provides access to view and edit the first node.

13. The system of claim 8, wherein at least one processor is further configured to verify the first and second transfers, the verifying comprising:
calculating a first hash value of the first node;
calculating a second hash value of the second node; and
determining that the first hash value equals the second hash value.

14. The system of claim 13, wherein the first hash value and the second hash value are calculated using a one-way, cryptographic hash function.

15. A non-transitory computer-readable device having instructions stored thereon that, when executed by at least one computing device, cause the at least one computing device to perform operations comprising:
receiving a request from a device, wherein the request includes an amount of funds, a payor identifier, and a payee identifier;
obtaining permission for the request using the payor identifier;
in response to obtaining the permission, performing a first transfer wherein the amount of funds is transferred from an account associated with the payor identifier to an account associated with a centralized server system;
in response to the first transfer, recording the amount of funds to a first node on a blockchain managed by the centralized server system, wherein the first node is associated with the payor identifier;
performing a second transfer, wherein the amount of funds is transferred from the account associated with the centralized server system to an account associated with the payee identifier; and
in response to the second transfer, recording the amount of funds to a second node on the blockchain, wherein the second node is associated with the payee identifier.

16. The non-transitory computer-readable device of claim 15, wherein recording the first transfer is performed by executing a smart contract configured to execute when the first transfer is complete, and wherein recording the second transfer is performed by executing a smart contract configured to execute when the second transfer is complete.

17. The non-transitory computer-readable device of claim 15, wherein obtaining permission for the request further comprises receiving approval from a payor device associated with the payor identifier.

18. The non-transitory computer-readable device of claim 15, wherein obtaining permission for the request further comprises comparing the request to the first node, wherein the first node includes an entry indicating preapproval of the request.

19. The non-transitory computer-readable device of claim 15, the operations further comprising verifying the first transfer and the second transfer, the verifying comprising:
calculating a first hash value of the first node;
calculating a second hash value of the second node; and
determining that the first hash value equals the second hash value.

20. The non-transitory computer-readable device of claim 19, wherein the first hash value and the second hash value are calculated using a one-way, cryptographic hash function.
